(19) United States
(12) Patent Application Publication
(10) Pub. No.: US 2009/0097229 A1
(43) Pub. Date: Apr. 16, 2009

(54) LIGHT MANAGEMENT FILMS, BACK LIGHT UNITS, AND RELATED STRUCTURES

(75) Inventors: Robert L. Wood, Apex, NC (US); John Wilson, Durham, NC (US)

Correspondence Address: MYERS BIGEL SIBLEY & SAJOVEC, PO BOX 37428, RALEIGH, NC, 27627, US

(73) Assignee: Bright View Technologies, Inc.

(21) Appl. No.: 12/249,557

(22) Filed: Oct. 10, 2008

Related U.S. Application Data
(60) Provisional application No. 60/979,466, filed on Oct. 12, 2007.

(51) Int. Cl. F21V 13/04

(52) U.S. Cl. 362/97.1; 362/327

(57) ABSTRACT

A light management film can be provided by an optically transparent substrate and an array of microlenses that is formed in a first side of the optically transparent substrate. An optically reflective layer is provided on a second side of the substrate that is opposite the first side, where the optically reflective layer includes apertures therein that are self-aligned to the microlenses.

### CROSS REFERENCE TO RELATED APPLICATIONS

This application claims the benefit of priority to U.S. Provisional Application Ser. No. 60/979,466 filed Oct. 12, 2007, and to U.S. patent application Ser. No. 11/053,998, filed Feb. 9, 2005, which claimed the benefit of U.S. Provisional Application Ser. Nos. 60/544,036, filed Feb. 12, 2004, entitled Microlens Arrays With Aperture Masks Having Randomized Apertures and Methods of Fabricating Same; 60/544,018, filed Feb. 12, 2005, entitled Microlens Arrays With Aperture Masks Having Multiple Apertures Per Lens and Methods of Fabricating Same; 60/544,027, filed Feb. 12, 2004, entitled Microlens Arrays With Aperture Masks Having Varying Aperture Shapes and Methods of Fabricating Same; 60/544,026, filed Feb. 12, 2004, entitled Microlens Arrays With Aperture Masks Having Apertures That Include Diffusive Materials and Methods of Fabricating Same; 60/546,819, filed Feb. 19, 2004, entitled Microlens Arrays With Contrast Enhancing and/or Light Management Films for Use With LCD or Other Displays; 60/545,875, filed Feb. 19, 2004, entitled Retroreflectors Including Microlens Arrays and/or Optical Mask Layers, and Methods of Fabricating Retroreflectors; 60/545,873, filed Feb. 19, 2004, entitled Sieves and Moulds for Micron-Sized Particles and Methods of Using Same to Sieve and/or Mold Micron-Sized Particles; 60/551,560, filed Mar. 9, 2004, entitled Light Management Films for Backlit Displays and Methods of Making and Using Same; 60/551,410, filed Mar. 9, 2004, entitled Stampers for Micromolding Applications Including Photocurable Polymers, and Methods of Making and Using Same; 60/551,403, filed Mar. 9, 2004, entitled IR Laser Beam Locator and Profiles and Methods of Making and Using Same; 60/551,404, filed Mar. 9, 2004, entitled Anti-Glare Films With Anisotropic Light Dispersive Properties and Methods of Making and Using Same, and 60/613,445, filed Sep. 27, 2004, entitled Light Management Films for Backlit Displays and Methods of Making and Using Same. All of these applications are assigned to the assignee of the present application, the disclosure of all of which are hereby incorporated herein by reference in their entirety as if set forth fully herein.

### FIELD

This invention relates to optics for displays and related structures.

### BACKGROUND

Microlens arrays are used in applications where gathering light from a source and then directing it to various locations and in various angles is desirable. Such applications include computer displays, screens for projection televisions, and certain illumination devices. The utility of the array can often be enhanced by inclusion of an aperture mask which only permits light to pass through the array in certain directions and which absorbs ambient light which would otherwise reflect off of the surface of the array and degrade the effective contrast of the optical system. Such arrays and masks with apertures may be conventionally formed at the points at which the lenses focus paraxial radiation.

Conventional techniques for creating microlens arrays with aperture masks may involve fabrication of the arrays on suitable substrates which are or can be coated with appropriate radiation absorbing mask materials. High intensity radiation is then directed through the lenses and focused by them. If the structure of the lens array, substrate and mask has been designed so that the focal points of the lens array are at or near the mask layer, the radiation will form apertures in the mask at these focal points. See, for example, U.S. Pat. No. 4,172,219 to Deml et al., entitled Daylight Projection Screen and Method and Apparatus for Making the Same.

### SUMMARY

Embodiments according to the invention can provide light management films, back light units, and related structures. Pursuant to these embodiments, a light management film can be provided by an optically transparent substrate and an array of microlenses that is formed in a first side of the optically transparent substrate. An optically reflective layer is provided on a second side of the substrate that is opposite the first side, where the optically reflective layer includes apertures therein that are self-aligned to the microlenses.

In some embodiments according to the invention, a display film includes a first light management film and a second light management film that is downstream from the first light management film relative to a light source for the display. Further, the second light management film can include a second light management film optically transparent substrate and a second light management film array of microlenses that are on the second light management film optically transparent substrate, which is configured to collimate incident light that is received from the first light management film at or less than an incident angle, toward a viewer and which is configured to reflect incident light that is received from the first light management film at greater than the incident angle back toward the first light management film.

In some embodiments according to the invention, a back light unit (BLU) can include a light management film that further includes an optically transparent substrate and an array of microlenses formed in a first side of the substrate. An optically reflective layer, including apertures therein, is located on a second side of the substrate opposite the first side. A display back light source is located upstream from the light management film and a haze plate is located between the display back light source and the light management film. A reflector is positioned on an opposing side of the display back light source relative to the haze plate.

In some embodiments according to the invention, a back light unit (BLU) can include a light guide plate that is configured to guide light incident from at least one edge thereof toward a center portion of the light guide plate. An edge light source is located at the at least one edge of the light guide plate and is configured to emit light toward the light guide plate. An edge light source reflector is located at the edge of light guide plate where the edge light source is located between the edge light source reflector and the edge of the light guide plate. A light management film is located between the light guide plate and a viewer, where the light management film can include an optically transparent substrate and an array of microlenses formed in a first side of the optically transparent substrate. An optically reflective layer is on a second side of the substrate, opposite the first side, and includes apertures therein that are self-aligned to the microlenses.

In some embodiments according to the invention, a light management film can include an optically transparent substrate and an array of microlenses on one side of the substrate, where the microlenses have a focal length. An optically reflective layer is on the other side of the substrate and contains apertures therein, where the optically reflective layer is spaced apart from the array of microlenses by about the focal length.

### BRIEF DESCRIPTION OF THE FIGURES

FIG. 1 is a cross sectional view that illustrates a light management film including an array of microlenses formed on an optically transparent substrate with an optically reflective layer thereon having apertures formed therein which are self-aligned to the microlenses in some embodiments according to the invention.

FIG. 2 is a cross sectional view that illustrates a light management film including an array of microlenses formed on an optically transparent substrate with an optically reflective layer thereon having apertures formed therein which are self-aligned to, but not co-axial with the optical axes of the microlenses in some embodiments according to the invention.

FIG. 3 is a cross sectional view that illustrates a light management film including an array of microlenses on an optically transparent substrate having an optically reflective layer formed thereon with apertures formed therein mounted on an optically transparent laminate layer using a low refractive index glue in some embodiments according to the invention.

FIG. 4 is a cross sectional view that illustrates a light management film including at least two arrays of microlenses on one another in some embodiments according to the invention.

FIGS. 5A-5C are cross sectional views that illustrate methods of forming an array of microlenses on an optically transparent substrate having an optically reflective layer formed thereon having apertures therein to provide a light management film in some embodiments according to the invention.

FIG. 6 in a schematic diagram of a back light unit including a light management film is some embodiments according to the invention.

FIG. 7 is a schematic diagram of an edge lit back light unit including a light management film in some embodiments according to the invention.

### DESCRIPTION OF EMBODIMENTS ACCORDING TO THE INVENTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. In the drawings, the thickness of layers and regions may be exaggerated for clarity. Like numbers refer to like elements throughout. As used herein the term “and/or” includes any and all combinations of one or more of the associated listed items and may be abbreviated as “/”.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “having,” “having,” “includes,” and/or “including” when used in this specification, specify the presence of stated features, regions, steps, operations, elements, and/or components, but do not preclude the presence or addition of one or more other features, regions, steps, operations, elements, components, and/or groups thereof.

It will be understood that when an element such as a layer or region is referred to as being “on” or extending “onto” another element (or variations thereof), it can be directly on or extend directly onto the other element or intervening elements may also be present. In contrast, when an element is referred to as being “directly on” or extending “directly onto” another element (or variations thereof), there are no intervening elements present. It will also be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present. Finally, when an element is referred to as “holding” another element (or variations thereof), it can directly hold the other element or intervening elements may be present. In contrast, when an element is referred to as “directly holding” another element (or variations thereof), there are no intervening elements present.

It will be understood that, although the terms first, second, etc. may be used herein to describe various elements, components, regions, layers and/or sections, these elements, materials, regions, layers and/or sections should not be limited by these terms. These terms are only used to distinguish one element, material, region, layer or section from another element, material, region, layer or section. Thus, a first element, material, region, layer or section discussed below could be termed a second element, material, region, layer or section without departing from the teachings of the present invention.

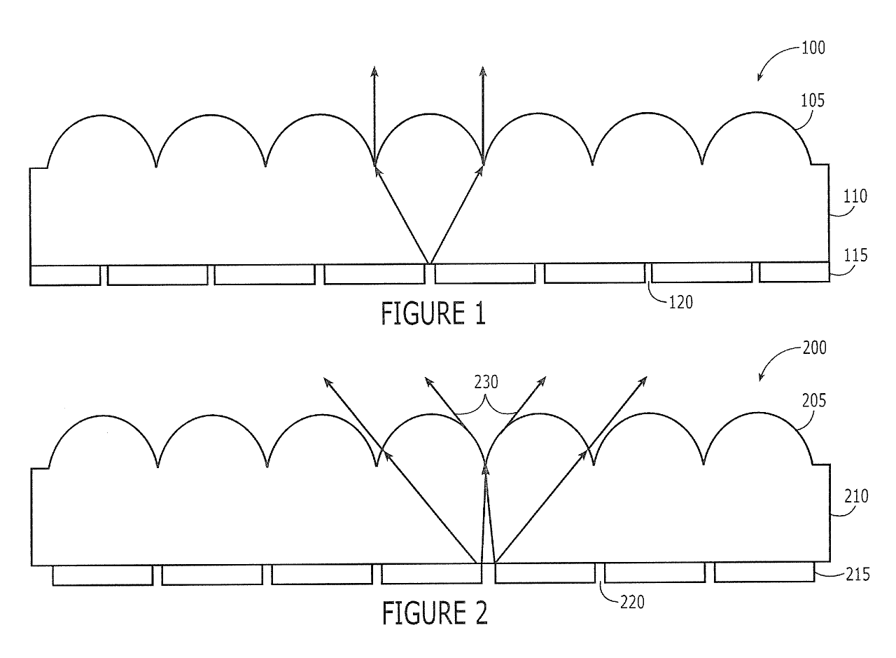

Relative terms, such as “lower”, “base”, or “horizontal”, and “upper”, “top”, or “vertical” may be used herein to describe one element's relationship to another element as illustrated in the Figures. It will be understood that relative terms are intended to encompass different orientations of the device in addition to the orientation depicted in the Figures. For example, if the structure in the FIG. 1 is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the structure in one of the figures is turned over, elements described as “below” or “beneath” other elements would then be oriented “above” the other elements. The exemplary terms “below” or “beneath” can, therefore, encompass both an orientation of above and below. Moreover, the terms “front” and “back” may be used to describe opposing outward faces of a structure.

Embodiments of the present invention are described herein with reference to cross section and perspective illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated, typically, may be rounded. Thus, the regions illustrated in the figures are schematic in nature and their shapes are not intended to illustrate the precise shape of a region and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. Finally, the functionality of one or more blocks of the figures may be separated and/or combined with that of other blocks.

In some embodiments according to the invention, a light management film includes an optically transparent film substrate having an array of optical microlenses on a first surface, and a reflective layer on an opposing surface of the substrate. The reflective layer may have apertures therein that permit light arriving at the aperture side of the optically transparent film to transit the optically transparent film and exit via the microlens side.

In some embodiments according to the invention, the array of optical microlenses can include an array of microlenses having respective focal properties. The focal property may be represented as the ability to produce an illuminated area on the aperture side of the film that is smaller than the cross-sectional area of the optical microlens itself when illuminated with collimated light from the microlens side of the film. This focal area may be at a defined distance from the microlens itself and may be further defined as the effective focal length of the lens.

In some embodiments according to the invention, the microlens may have shapes that are spherical, aspherical, lenticular, planar, faceted, or some combination thereof.

In some embodiments according to the invention, the microlens may be a circularly symmetric structure with an axis of symmetry parallel to the optical axis of the lens. In other embodiments according to the invention, the lens may be cylindrical, with curvature in only one direction. In other embodiments according to the invention, the lens may be anamorphic, having differing curvature in two mutually orthogonal directions. In yet other embodiments according to the invention, lenses may be asymmetric and produce a focal zone that is not located along the optical axis of the lens. Combinations of lens shapes and sizes may also be used.

In some embodiments according to the invention, the microlenses may be arranged on the surface of the substrate in a variety of manners, including a square-packing arrangement, random packing arrangement, or hexagonal close-packed arrangement. Further, in some embodiments according to the invention, some of the microlenses arranged in any of these packed arrangement can be grouped together, and the groups can be oriented in different ways. As appreciated by the present inventors, this type of variation in the orientation of the groups can reduce an interference pattern that may otherwise be created by the optical interaction of the light management film and an LCD panel.

In some embodiments according to the invention, the reflective layer opposing the microlens side may be at a distance corresponding to the effective focal length of the lens to provide relatively high levels of light management. In other embodiments the reflective layer may be at a distance that is different from the focal length. The latter embodiments may produce a lower degree of light management compared to the former embodiments. In some embodiments according to the invention, there may be one or more apertures within the reflective layer associated with each microlens.

In some embodiments according to the invention, the reflective layer may be aluminum, silver, chromium, and/or the like, deposited by evaporation and/or sputtering. Reflector layer thickness may be 10 nm or more, most preferably 50 nm or more. Substrates may be selected from optically transparent media with appropriate thickness such as polyethyleneterephthalate (PET) film, polycarbonate film, acrylic film, triacetate cellulose (TAC) film, and/or the like. Microlenses may be optically transparent plastic materials as previously disclosed.

In some embodiments the lens height, width, focal length, substrate thickness, and aperture size may be selected such that the majority of light rays (and in some embodiments substantially all) entering the film from an air interface through a first aperture on the aperture side of the film may emerge from a microlens corresponding to the first aperture, regardless of incidence angle.

In some embodiments according to the invention, light that is received in all directions is collimated, i.e. light exiting the film may be collimated into a cone of angles where the cone angle is defined and the cone itself is circularly symmetric along the optical axis. In other words, in some embodiments according to the invention, the film can collimate all received light, regardless of the direction in which it is received. In other embodiments, the cone may be elliptically shaped. In yet other embodiments, the cone may be either elliptical or circular and not parallel to the optical axis, i.e. not perpendicular to the film itself. In some embodiments the light management film may provide collimation only along one axis, while producing little or no collimation along other directions, and may provide a plane of collimation that is either perpendicular or tilted with respect to the substrate. Multiple planes of collimation may be provided by using two or more apertures in association with each lens.

In some embodiments a back light unit (BLU) may be constructed using a light management film, as described above, in conjunction with one or more light sources (such as fluorescent tubes and/or LEDs), one or more diffusers, and a back-plane reflector. Some embodiments may further employ an edge-lit light guide plate (LGP) having one or more sources of light along one or more of its edges. The BLU may have vertical and horizontal viewing directions, and the light management film may be designed and oriented in a manner to independently define light diffusion properties along the horizontal and vertical directions. The light management film may be oriented such that the reflective layer faces the light source side while the microlens layer faces the viewer side.

In some embodiments according to the invention, the BLU may contain multiple optical films between the light source and viewer side, with at least one being a light management film according to embodiments of the invention. In some embodiments the light management film may be stacked with other optical films such as beaded gain films, microlens films, diffuser films, prism films, and/or reflecting polarizers.

In some embodiments according to the invention, a light management film may increase the brightness of a BLU in at least one direction while restricting its viewing angle along at least one direction.

In some exemplary embodiments according to the invention, as illustrated by FIG. 1, a light management film 100 was fabricated by microreplication of an array of cylindrically shaped microlenses 105 formed in one surface of a polyethyleneterephthalate (PET) film 110 having a thickness of about 66 μm, sometimes referred to herein as an optically transparent substrate. Microreplication was performed as disclosed in, for example, U.S. Patent Application Nos. 2006/0061869; 2005/0058947; 2005/0058948; 2005/0058949 and/or 2003/00206342 and/or 2006/0164729; and/or U.S. Pat. Nos. 6,967,779; 6,829,087, 6,816,306 and/or 7,092,166 and/or U.S. application Ser. Nos. 11/113,846; 11/179,162, 11/364,423, 11/378,189, 11/382,163, 11/414,875, 11/465,373, 11/465,358 and/or 11/465,377, all of which are currently assigned to the assignee of the present invention.

The cylindrical microlenses 105 had a pitch of about 95 μm, a height of about 40 μm, and a shape outline defined by a biconic equation resulting in an aspherical convex lens cross-section. The microlenses 105 had a focal length of about 66 μm as measured inside of the PET film 110. The opposite surface of the PET film 110 had a optically reflective layer 115 of aluminum with a thickness of about 60 μm. In some embodiments according to the invention, other reflective materials, such as silver could be used.

Following microreplication, the film 100 was exposed, at normal incidence from the microlens side, using a high pulse rate laser as disclosed in, for example, U.S. patent application Ser. No. 11/382,163, filed May 8, 2006 (U.S. Patent Publication No. 2007/0258149) entitled Methods and Apparatus for Processing a Pulsed Laser Beam to Create Apertures Through Microlens Arrays, and Products Produced Thereby, to remove the aluminum coating in the regions corresponding to the microlens focal points. The removal resulted in a narrow slot cut away from the aluminum layer, producing transparent apertures 120 running in a direction parallel to the cylindrical lenses and having a width of about 7 μm. Accordingly, the apertures 120 were self-aligned to respective ones of the microlenses 105 through which the laser was incident so that the microlenses 105 are in registry with the respective transparent apertures 120 and coaxial with optical axes of the microlenses.

In some embodiments according to the invention, the pitch of the microlenses is about 90 μm, the height of the microlenses is about 30 μm, where the microlenses 105 had a focal length of about 66 μm as measured inside of the PET film 110. In some embodiments according to the invention, the thickness of the optically reflective layer 115 is about 80 nm. In some embodiments according to the invention, the refractive index of the PET film is about 1.5 to about 1.7. In some embodiments according to the invention, the size of the apertures 120 is about 10 percent of the total area of the optically reflective layer. In some embodiments according to the invention, the size of the apertures 120 is about 10 percent of the total area of the substrate area on which the optically reflective layer is located.

Accordingly, in some embodiments according to the invention, light management films can be provided with arrays of microlenses where the microlenses are formed into the optically transparent substrate, which are spaced apart as described herein by, for example, about 5 to about 100 microns, over a sufficiently large area to provide a screen apparatus for a display, such as a display (such as an LCD) for a computer, a television, or other similar display device. This approach can provide light management films for relatively large format displays that are essentially seamless as the films in some embodiments according to the invention can be formed as unitary structure on a large scale dimensions suitable for a display for, for example, a large screen television.

In some embodiments according to the invention as shown in FIG. 2, a light management film 200 is provided by forming an array of microlenses 205 on a optically transparent substrate 210 having an optically reflective layer 215 formed on an opposing side thereof. The optically reflective layer 215 includes apertures 220 formed therein which are self aligned to and are not in registry with the respective microlenses in the array 205. In particular, the apertures 220 are self-aligned due to the formation of the apertures 220 in the optically reflective layer 215 using laser light projected through the microlens array 205 so as to remove portions of the optically reflective layer 215, which correspond to the portions at which the laser light impinges on the optically reflective layer 215. Further, the apertures 215 are not coaxial with optical axes of the microlenses, as the apertures 220 are offset from the optical axis of the respective microlens in the array 205. It will be noted, however, that even when the apertures 220 are offset from the optical axis of the respective microlens in the array 205, the apertures can be self-aligned to boundaries between immediately adjacent microlenses in the array 205.

Accordingly, light can pass through the apertures 220, through the optically transparent substrate 210, to the microlenses in the array 205, which refracts the light incident thereon primarily in a direction which is off-center from the optical axes of the microlenses in the array 205 as shown by rays 230. Therefore, the light management film 200 can provide images to viewers which are off center of the optical axes of the microlenses 205. For example, the light management unit 200 may be used in a display where the viewers are seated side-by-side and the display is located between the two viewers. Therefore, the rays 230 can refract the light toward each of the viewers which are located off-center of the optical axes of the microlenses 205.

In some embodiments according to the invention, the pitch of the microlenses is about 90 μm, the height of the microlenses is about 30 μm, where the microlenses 105 had a focal length of about 66 μm as measured inside of the PET film 110. In some embodiments according to the invention, the thickness of the optically reflective layer 115 is about 80 nm. In some embodiments according to the invention, the refractive index of the PET film is about 1.5 to about 1.7. In some embodiments according to the invention, the size of the apertures 120 is about 10 percent of the total area of the optically reflective layer. In some embodiments according to the invention, the size of the apertures 120 is about 10 percent of the total area of the substrate area on which the optically reflective layer is located.

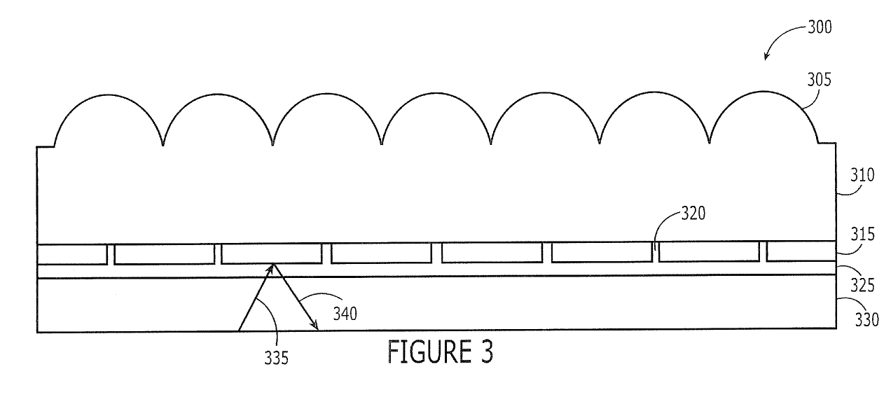

In some embodiments according to the invention as shown in FIG. 3, a transparent laminate layer 330 can be attached to the apertures with a low-refractive index glue layer 325 to allow for increased light recycling by a light management film 300. In some embodiments according to the invention, the light management film 300 can be provided by forming an array of microlenses 305 in an optically transparent substrate 310 with an optically reflective layer 315 formed on an opposite side thereof. The optically reflective layer 315 includes apertures 320 formed therein in registry with and self-aligned to the microlenses in the array 305.

Further, the optically transparent laminate layer 330 can be mounted to the aperture side of the optically transparent substrate 310 using the low-refractive index glue 325. Light 335 that transits through the optically transparent laminate layer 330 is reflected from the optically reflective layer 315 back into the laminate layer 330 as light 340, with a reduced amount of reflection within the low-refractive index glue layer 325 due to the relationship between the refractive indices of the optically transparent laminate layer 330 and the low refractive index glue layer 325. In particular, the index of refraction associated with the optically transparent laminate layer 330 is greater than the refractive index associated with the glue layer 325. The relationship between theses two refractive indices can decrease the amount of light which may be otherwise internally reflected within the low-refractive index glue layer 325 (and potentially escape through an edge of the light management film 300).

In some embodiments according to the invention, the pitch of the microlenses is about 90 μm, the height of the microlenses is about 30 μm, where the microlenses had a focal length of about 66 μm as measured inside of the optically transparent substrate 310. In some embodiments according to the invention, the thickness of the optically reflective layer 315 is about 80 nm. In some embodiments according to the invention, the refractive index of the optically transparent laminate layer 330 is about 1.5 to about 1.7. In some embodiments according to the invention, the refractive index of the glue layer 325 is about 1.3 to about 1.4. In some embodiments according to the invention, the refractive index of the optically transparent laminate layer 330 is greater than or equal to the refractive index of the glue layer 325.

In some embodiments according to the invention, the size of the apertures 120 is about 10 percent of the total area of the optically reflective layer. In some embodiments according to the invention, the size of the apertures 320 is about 10 percent of the total area of the substrate area on which the optically reflective layer is located.

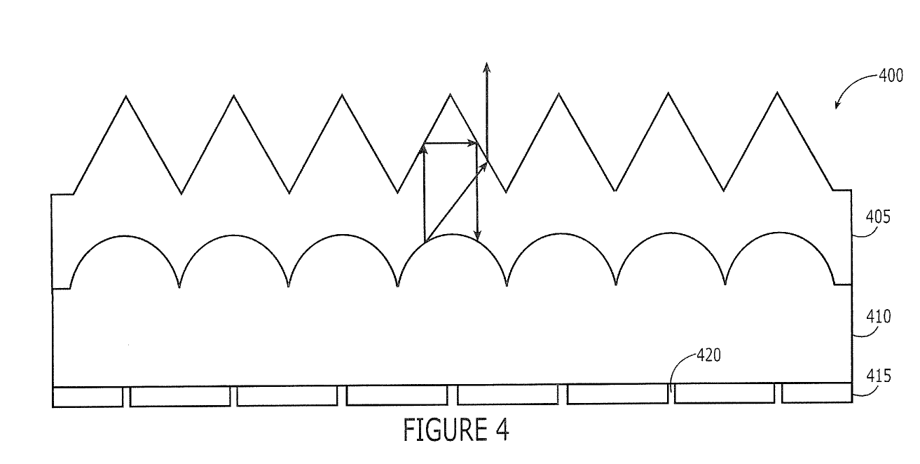

In some embodiments according to the invention, as shown for example in FIG. 4, a light management film 400 includes at least two arrays of microlenses formed on one another. In particular, the light management film 400 can include a first array of microlenses 405 having a triangular profile on an optically transparent substrate 410 all of which is on a second array of microlenses, as described above in reference to, for example, FIG. 1. Light refracted by the second array of microlenses toward the first array of microlenses 405 is refracted or reflected based on the angle of incidence upon the first array of micro structures 405. In particular, the triangular profile of the first array of microlenses 405 is configured to collimate incident light, which is received from the second light management film at or less than an incident angle, whereas light that is incident at greater than the incident angle is reflected back toward the second light management film. Accordingly, the combination of the first and second light management films can provide a narrower range of collimated light from the first light management film 405.

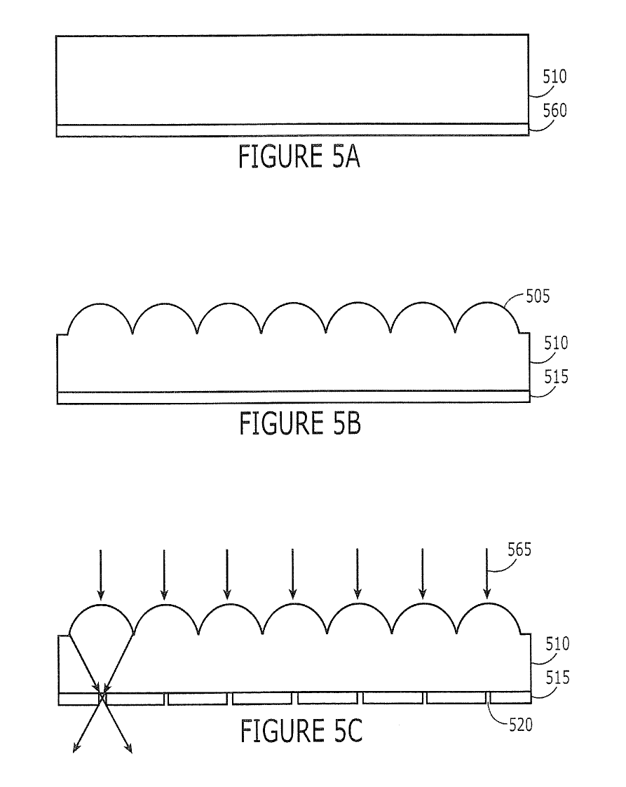

FIGS. 5A-5C are cross sectional views illustrating methods of forming light management films including microlens arrays in optically transparent substrates with optically reflective layers formed on opposite sides thereof having apertures formed therein that are self aligned to and in registry with the microlenses in the array in some embodiments according to the invention.

According to FIG. 5A, an optically transparent substrate 510 is coated with an optically reflective layer 560, such as silver. According to FIG. 5B, an upper surface of the optically transparent substrate 510 is stamped with a master to form an array of microlenses 505 and the optically transparent substrate 510 as a unitary structure, formed of the optically transparent substrate 510.

According to FIG. 5C, laser light is impinged on the optically reflective layer 515 through the microlens array 505 to remove the corresponding portions of the optically reflective layer 515, which are self aligned to and in registry with the microlenses in the array 505 to form apertures 520 in the optically reflective layer 515.

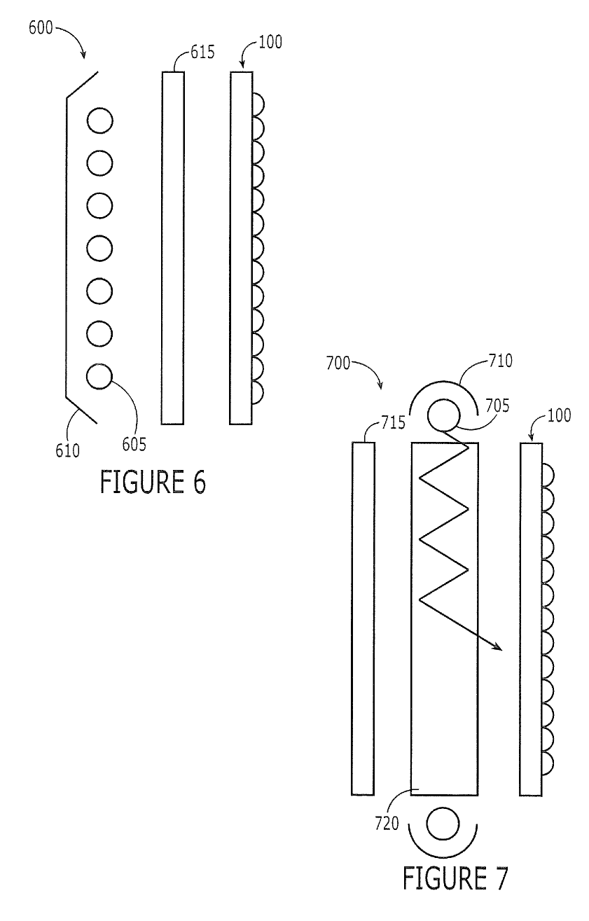

In some embodiments according to the invention, as illustrated by FIG. 6, a Back Light Unit (BLU) 500 was combined with the light management film 100. The BLU 500 was constructed by orienting CCFL light bulbs 605 horizontally in an array, with separation of about 1″ between bulbs. A white reflector 610 with diffuse reflectance of about 95% was placed behind the bulbs 605 with a gap of less than one quarter of an inch from the reflector 610. A haze diffuser plate 615, about 2 mm in thickness, was placed in front of the bulbs with a separation of about one half inch to diffuse the light sources according to a more uniform distribution over the surface of the haze plate. In some embodiments according to the invention, Light Emitting Diodes (LEDs) can be used as the light source(s).

Measurement of the backlight luminance versus view angle showed a circularly symmetric light distribution with nearly constant luminance within a cone of ±80°, and on-axis luminance of about 7000 cd/m2. This backlight was covered with the light management film 100 of FIG. 1, with the cylindrical lenses oriented in a horizontal direction, and an air gap included between the top surface of the haze plate 615 and the back side of the light management film 100.

The light management film 100 was further oriented such that the optically reflective side 115 was in contact with the haze plate 615. With the light management film 100 in place, the BLU 500 had an on-axis luminance of 15,000 cd/m2. Luminance measured in a vertical direction showed that brightness declined by more than 90% within ±10° of the optical axis, while the brightness distribution in the horizontal direction did not change significantly.

In some embodiments according to the invention, as illustrated by FIG. 7, an edge lit BLU can be combined with the light management film 100. According to FIG. 7, the BLU 700 includes a light source 705 located at an edge of a light guide plate 720, which is configured to guide light from the light source 705 in to an edge of the light guide 720 and along the length thereof and ultimately out of the light guide plate 720 toward the light management film 100 for projection to a viewer. The BLU 700 also can include a reflector 715, which is configured to reflect any light which is emitted from the light guide plate 720 in a direction that is opposite to the light management film 100 and the viewer and reflect that light back through the light guide plate 720 and ultimately to the viewer through the light management film 100.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

What is claimed:

1. A light management film comprising:
an optically transparent substrate;
an array of microlenses on one side of the substrate, the microlenses having a focal length; and
an optically reflective layer on the other side of the substrate and containing apertures therein, the optically reflective layer being spaced apart from the array of microlenses by about the focal length.

2. A light management film comprising:
an optically transparent substrate;
an array of microlenses formed in a first side of the optically transparent substrate; and
an optically reflective layer on a second side of the substrate, opposite the first side, including apertures therein self-aligned to the microlenses.

3. A light management film according to claim 2 wherein the apertures are in registry with the microlenses.

4. A light management film according to claim 2 wherein the apertures are not in registry with the microlenses.

5. A light management film according to claim 2 further comprising:
a glue layer having a first index of refraction on the optically reflective layer opposite the substrate; and
an optically transparent laminate layer having a second index of refraction, greater than the first index of refraction, on the glue layer opposite the optically reflective layer.

6. A light management film according to claim 2 wherein the optically reflective layer comprises silver.

7. A display film according to claim 2 wherein the optically transparent substrate and the array of microlenses comprise a unitary structure.

8. A display film according to claim 2 wherein the microlenses comprise circular or anamorphic shaped microlenses.

9. A display film according to claim 2 wherein the array of microlenses comprises a square-packing arrangement, a random packing arrangement, or hexagonal close-packed arrangement.

10. A display film according to claim 2 wherein the apertures are coaxial with optical axes of the microlenses.

11. A display film according to claim 2 wherein the apertures are non-coaxial with optical axes of the microlenses.

12. A display film comprising:
a first light management film; and
a second light management film downstream from the first light management film relative to a light source for the display, wherein the second light management film comprises:
a second light management film optically transparent substrate;
a second light management film array of microlenses on the second light management film optically transparent substrate configured to collimate incident light received from the first light management film at or less than an incident angle toward a viewer and to reflect incident light received from the first light management film at greater than the incident angle back toward the first light management film.

13. A display film according to claim 12 wherein the first light management film comprises:
a first light management film optically transparent substrate;
a first light management film array of microlenses formed in a first side of the substrate; and
a first light management film optically reflective layer on a second side of the substrate, opposite the first side, including apertures therein self-aligned to the first light management film microlenses.

14. A display film according to claim 13 wherein the apertures in the first light management film optically reflective layer are in registry with the first light management film array of microlenses.

15. A display film according to claim 13 wherein the apertures in the first light management film optically reflective layer are not in registry with the first light management film array of microlenses.

16. A display film according to claim 13 further comprising:
a glue layer having a first index of refraction on the first light management film optically reflective layer opposite the substrate; and
an optically transparent laminate layer having a second index of refraction, greater than the first index of refraction, directly on the glue layer opposite the optically reflective layer.

17. A display film according to claim 12 wherein the second light management film array of microlenses have triangular profiles.

18. A display film according to claim 13 wherein the first light management film optically reflective layer comprises silver.

19. A display film according to claim 13 wherein the apertures in the first light management film optically reflective layer are formed self-aligned to the first light management film array of microlenses by impinging laser light onto the first light management film optically reflective layer through the first light management film array of microlenses to remove respective portions of the first light management film optically reflective layer where the laser light impinges to provide a unitary structure including the first light management film optically transparent substrate and the first light management film array of microlenses formed thereon.

20. A back light unit (BLU) comprising:
a light management film including:
an optically transparent substrate;
an array of microlenses formed in a first side of the substrate; and
an optically reflective layer, including apertures therein, located on a second side of the substrate opposite the first side;
a display back light source upstream from the light management film;
a haze plate located between the display back light source and the light management film; and
a reflector positioned on an opposing side of the display back light source relative to the haze plate.

21. A back light unit (BLU) comprising:
a light guide plate configured to guide light incident from at least one edge thereof toward a center portion of the light guide plate;
an edge light source located at the at least one edge of the light guide plate and configured to emit light toward the light guide plate;
an edge light source reflector located at the edge of light guide plate having the edge light source located between the edge light source reflector and the edge of the light guide plate;
a light management film located between the light guide plate and a viewer including:
an optically transparent substrate;
an array of microlenses on a first side of the optically transparent substrate; and
an optically reflective layer on a second side of the substrate, opposite the first side, including apertures therein self-aligned to the microlenses.

22. A BLU according to claim 21 wherein the apertures are self-aligned to and in registry with the microlenses.

23. A BLU according to claim 18 wherein the apertures are not in registry with the microlenses.

24. A BLU according to claim 21 further comprising:
a glue layer having a first index of refraction on the optically reflective layer opposite the substrate; and
an optically transparent laminate layer having a second index of refraction, greater than the first index of refraction, on the glue layer opposite the optically reflective layer.

25. A BLU according to claim 21 wherein the optically reflective layer comprises silver.

26. A light management film comprising:
an optically transparent substrate;
an array of microlenses formed in a first side of the optically transparent substrate spaced apart by about 5 microns to about 100 microns formed as a seamless unitary structure with the optically transparent substrate over an area that is sufficiently large for seamless coverage of a display upto television size; and
an optically reflective layer on a second side of the substrate, opposite the first side, including apertures therein self-aligned to the microlenses.
